(19) United States
(12) Patent Application Publication
(10) Pub. No.: US 2016/0263858 A1
(43) Pub. Date: Sep. 15, 2016

(54) LIGHTWEIGHT AND ROBUST MOTOR VEHICLE STRUCTURAL PART AND METHOD FOR THE MANUFACTURE THEREOF

(71) Applicants: FAURECIA AUTOMOTIVE INDUSTRIE, Nanterre (FR); LINEO NV, Meulebeke (BE); PEUGEOT CITROEN AUTOMOBILES SA, Velizy-Villacoublay (FR); UNIVERSITE DE REIMS CHAMPAGNE-ARDENNE, Reims Cedex (FR)

(72) Inventors: Frédéric ROUSSEAU, Dourdan (FR); Moussa KHALFALLAH, Reims (FR); François VANFLETEREN, Bernay (FR); Boussad ABBES, Beaumont-Sur-Vesle (FR); Valérie MARCEL, Brandenville (FR)

(73) Assignees: Faurecia Automotive Industrie, Nanterre (FR); Lineo NV, Meulebeke (BE); Peugeot Citroen Automobiles SA, Velizy-Villacoublay (FR); Universite de Reim Champagne-Ardenne, Reims Cedex (FR)

(21) Appl. No.: 15/029,988

(22) PCT Filed: Oct. 17, 2014
(86) PCT No.: PCT/EP2014/072372

§ 371 Date: Apr. 15, 2016

(30) Foreign Application Priority Data
Oct. 18, 2013 (FR) 13 60189

(51) Int. Cl. B32B 5/26; B29C 70/46; B32B 27/18

(52) U.S. Cl. CPC B32B 5/26; B32B 27/18; B29C 70/46; B32B 27/308

(57) ABSTRACT

A structural part (10) for a motor vehicle includes first (12A) and second (12B) mats, each mat comprising fibers and a resin bonding the fibers, and a separator (14) inserted between the first (12A) and second (12B) mats, the first (12A) and second (12B) mats being fixed on opposite faces of the separator (14). At least one of the first (12A) and second (12B) mats includes at least one continuous web of fibers (16), said web (16) comprising a plurality of parallel fibers bonded together by a thermosetting resin, at least part of the fibers of each web (16) having a length greater than 20 cm, in particular greater than 50 cm.

### TECHNICAL FIELD

The present invention relates to a composite structural part of a motor vehicle that is particularly light and has satisfactory mechanical characteristics.

More particularly, the invention relates to a panel for a motor vehicle, for example a rear tray concealing a trunk, a false bottom of a passenger compartment or trunk, or a sub-motor.

### BACKGROUND

A structural motor vehicle part is already known in the state of the art of the type including:
first and second mats, forming outer skins, each mat including fibers and a resin binding the fibers, and
a separator inserted between the first and second mats, the first and second mats being fixed on opposite faces of the separator.

A “mat” refers to any essentially fibrous assembly, irrespective of whether it is associated with an impregnating resin. Such a mat can be of a nonwoven type, in which case it is generally made by carding-burling (commonly called “dry method”), by a paper method (also called “wet method”), by pneumatic carding (also called “airlay”) or done directly after extrusion of filaments such as meltblowns (nonwovens of the “spunbond” or “meltblown” type).

The specifications generally impose certain characteristics for such a structural part. In particular, the structural part must have the lowest possible mass, good mechanical characteristics, primarily good flexion and creep behavior at high temperatures (85° C.), and be able to have three-dimensional shapes, for example to have concave shapes allowing the inclusion of complementary parts such as handles, and/or have edges with particular profiles, in particular rounded or curved.

The specifications also generally require that the structural part include components of natural origin, for recycling or reduced environmental impact reasons.

Lastly, such a structural part must remain cost-effective, such that its manufacturing method must be particularly simple and require few investments, and this method must in particular have a single pressing step only requiring one mold.

The structural parts of natural origin known in the state of the art do not manage to meet all of these requirements. In particular, the mass of compressed homogenous panels with a base of wood or pressed wood, or with a base of linen, hemp, kenaf, etc. mats, is too high.

Furthermore, structural parts of the sandwich type made in a single pressing step, including a separator, generally made in a honeycomb and from cardboard, and skins with a base of natural fiber mats (wood, hemp, flax tow, kenaf) and resin, generally do not have satisfactory mechanical characteristics, in particular regarding the flexion and creep behavior, since the orientation of the fibers is not favored, the porosity and volume rate of fibers in the skins of these parts remaining low, resulting in a low density.

The production of such a structural part, made with two mats with short linen fibers and a cardboard separator in a single pressing step, is in particular described in WO 2012 056202. Nevertheless, with such a method, one sees that although it is indeed possible to assemble the components to obtain a sandwich-type part, the porosity of the mats is high (low density). Indeed, if an effort is made to compress the mats greatly to obtain an optimal high density, the pressure exerted by the mold becomes too high and causes crushing of the separator. Yet a critical high density is necessary to produce a true composite that will provide the best mechanical performance, since the resin must be pressed greatly to occupy as much space as possible between the fibers.

This problem of crushing of the separator results from the fact that mats, before compression, are too porous (density below 0.1), due to a random orientation of the fibers inherent to the carding/burling method used in WO 2012 056202, and therefore require extremely high pressures to be densified correctly. In particular, such a mat of 500 g/m², having a thickness of approximately 10 cm, should be reduced to a thickness of approximately 0.5 mm after compression to have a satisfactory densification.

That is why the structural parts of the sandwich type needing to meet these harsh specifications are typically done in two steps, for example as described in FR 2,971,198, i.e., a first step consisting of making the mats separately, and a second [step] consisting of associating the mats with the separator. In this case, however, there is a cost problem (due to the tooling and the cycle time), as previously mentioned.

### SUMMARY

The invention in particular aims to resolve these drawbacks by proposing a structural composite part made in a single pressing step that is relatively light (approximately 2000 g/m²), cost-effective, has good mechanical characteristics owing to high-density mats (low porosity) approaching true composites, and preferably comprising natural fibers.

To that end, the invention in particular relates to a motor vehicle structural part, of the type including:
first and second mats, each mat comprising fibers and a resin binding the fibers, and
a separator inserted between the first and second mats, the first and second mats being fixed on opposite faces of the separator,
   characterized in that at least one of the first and second mats includes at least one continuous web of fibers, said web comprising a plurality of parallel fibers bonded together by a thermosetting resin, at least part of the fibers of each web having a length greater than 20 cm, in particular greater than 50 cm.

It will be recalled that, in a continuous web of parallel fibers, which will be described in more detail below, the fibers may be organized so as to occupy a minimal volume, such that such a web makes it possible to obtain a composite with an optimal volume rate of fibers. Such a web can further be very light (the lower weight limit is 25 g/m²). Such a web forms a ply of unidirectional fibers.

Furthermore, such a web includes long fibers, such that, once reinforced by a resin, this web has a relatively high Young's modulus, with a density that is also high and a low porosity. In particular, a web of long linen fibers (between 50 and 80 cm) typically has a low weight (approximately 50 g/m²) and a significant width (up to 2 meters). Such a unidirectional web, associated with a thermosetting resin, has excellent mechanical characteristics (Young's modulus of 15 to 35 GPa (GigaPascal)), depending on the nature and resin level.

Such a structural part makes it possible to meet all of the requirements of the specifications as previously defined, and advantageously include fibers of natural origin.

A structural part according to the invention may further include one or more of the following features, considered alone or according to any technically possible combinations:
At least one, preferably each, of the first and second mats includes a plurality of continuous webs of stacked fibers, for example between three and eight stacked webs.
The webs are stacked such that the parallel fibers of each web are positioned so as to form a non-zero angle, in particular a right angle with the parallel fibers of each other adjacent web.
Each of the first and second mats including a plurality of continuous webs of stacked fibers, the first and second mats respectively include different numbers of stacked webs.
At least some of the parallel fibers are natural fibers, for example linen, hemp, kenaf or jute.
At least some of the parallel fibers are artificial or synthetic fibers, in particular thermoplastic.

The invention also relates to a method for manufacturing a structural part as previously defined, characterized in that it includes manufacturing a mat, comprising the following steps:
a step for providing a continuous web of fibers comprising long fibers, at least some of the long fibers of the web having a length greater than 20 cm, in particular greater than 50 cm, and
a step for impregnating the web with a compound including a thermosetting resin.

A manufacturing method according to the invention may further include one or more of the following features, considered alone or according to any technically possible combinations:
The impregnating compound includes at least one additive, for example pigments or dyes, a surfactant and/or a thickener.
The impregnation step is carried out using two cylinders, at least one of which includes slots for receiving a compound, the web of fibers passing between the cylinder such that the cylinders exert pressure on the web, ensuring the penetration of the compound in the web.
The impregnation step includes vaporization of the compound on the web, followed by expressing.
The impregnation step includes a vaporization of a compound on the web, followed by drying, then impregnation is done using two cylinders, at least one of which includes slots for receiving the compound, the web of fibers passing between the cylinders such that the cylinders exert pressure on the web, ensuring the penetration of the compound in the web.
The compound has a high solid content.
Each continuous web of fibers is made over the following steps:—a step for bringing a plurality of separate ribbons of fibers to be parallel, at least one ribbon containing long fibers, in particular natural long fibers;—a step for dispersion of the adjacent ribbons through a pin field to form a strip of parallel fibers;—a step for tensing and drawing the strip in the pin field parallel to a movement axis; and—a step for bonding the fibers of the stretched strip to form the web.
The manufacturing method comprises the following steps:—a step for stacking, in a heating mold, a first mat, a separator and a second mat, the separator being positioned between the first and second mats, and at least one of the first and second mats including at least one continuous web of fibers impregnated with the compound including a thermosetting resin; and—a step for compression and heating of the stack, the heating being done at a temperature and for a duration allowing the cross-linking of the thermosetting resin.

### BRIEF DESCRIPTION OF THE DRAWINGS

The invention will be better understood upon reading the following description, provided solely as an example, and done in reference to the appended drawings, in which:

FIG. 1 is a partial diagrammatic sectional view of a structural part according to one example embodiment of the invention;

FIG. 2 diagrammatically and partially shows a mat of the structural part of FIG. 1;

FIG. 3 diagrammatically shows the structural part of FIG. 1 during its manufacturing method.

### DETAILED DESCRIPTION OF THE ILLUSTRATED EMBODIMENT(S)

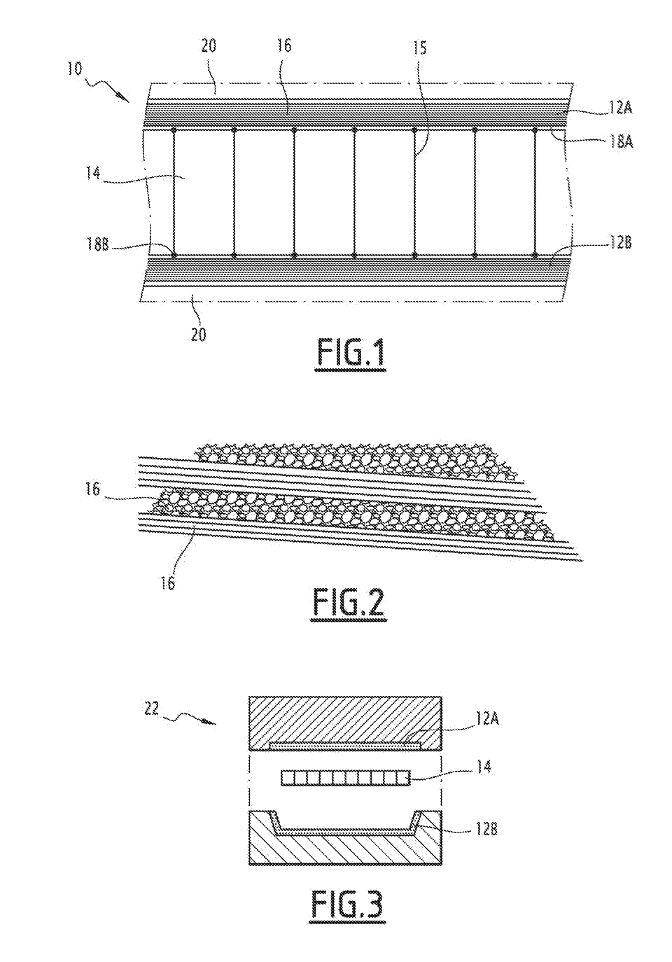

FIG. 1 shows the structural composite part 10 for a motor vehicle. The part 10 is a structural part of the motor vehicle, for example a panel, such as a rear tray concealing a trunk, a false bottom of a passenger compartment or trunk, or a sub-motor.

The structural composite part 10 includes a first 12A and second 12B mat, and a separator 14, inserted between the two mats 12A, 12B. More particularly, the first 12A and second 12B mats are attached on opposite faces of the separator 14.

Advantageously, the separator 14 is made with a base of a cellular or honeycomb structure. Thus, the separator 14 has a plurality of walls 15 substantially perpendicular to the plane of the structural part 10, the walls 15 defining central spaces with a closed contour forming the cells. Thus, each central space or cell emerges on either side opposite the first 12A or second 12B mat.

The cells for example define polygonal links, in particular hexagonal.

The separator 14 is advantageously made from a light material, such as paper or cardboard.

The surface density of the separator 14 is low. This density is preferably less than 1500 g/m² and is substantially comprised between 400 g/m² and 1200 g/m².

Thus, the structural part 10 has an appropriate lightness, due to the low density of the separator 14. More particularly, the structural part has a surface density of approximately 2 kg/m².

At least one of the first 12A and second 12B mats includes at least one continuous web of fibers 16, said web 16 comprising a plurality of parallel fibers bonded to one another by a thermosetting resin, at least part of the fibers of this web having a length greater than 20 centimeters, in particular 50 centimeters, for example comprised between 50 and 80 centimeters.

More particularly, in the illustrated example, each of the first 12A the second 12B mats includes a plurality of continuous webs of fibers 16, these webs 16 being stacked on one another. For example, each of the mats 12A, 12B includes between three and eight stacked webs.

Advantageously, the parallel fibers of each web 16 are positioned so as to form a non-zero angle, in particular a right angle with the parallel fibers of each other adjacent web, as in particular shown in FIG. 2. Such an arrangement makes it possible to reinforce the corresponding mat 12A, 12B, as a function of the orientation of the stresses of the finished part in position. Each fibers thus has a precise orientation, unlike the mats known from the state of the art for example made by carding/burling, in particular as described in WO 2012 056202.

It will be noted that the first 12A and second 12B mats can include the same number of stacked webs 16, or alternatively, different numbers of stacked webs 16. Indeed, depending on the intended function of the structural part 10, the two faces of the structural part 10 are for example not subject to the same stresses, such that it is not necessary for these two faces to have the same structural characteristics. Thus, a face of the structural part 10 that is subject to few stresses may include only a small number of webs 16. Reducing the number of webs 16 on a face makes it possible to reduce the mass of the structural part 10.

Preferably, at least some of the parallel fibers of each web are natural fibers. Natural fibers have many advantages compared to artificial or synthetic fibers.

In particular, natural fibers generally have a low density, a relatively low cost and an eco-friendly nature. Furthermore, natural fibers are renewable annually and can therefore be produced without exhausting natural resources.

In this context, the fibers from linen are widely cultivated used in many fields, and in particular to produce composite materials. Linen fibers are taken from the stem of the flax plant and can be used either in the form of bundles of technical fibers, or in the form of elementary fibers. In both cases, these fibers can have a length comprised between 30 and 80 cm. The term “linen fiber” here refers indifferently to the technical fiber or the elementary fiber. These long fibers must be differentiated from the flax tow, i.e., short fibers generally shorter than 10 cm.

In one embodiment, all of the fibers of at least one of the webs 16 are made up of natural long fibers. Alternatively, some of the fibers of at least one of the webs 16 are formed by artificial or synthetic fibers, separate from the natural long fibers, or a mixture of these fibers.

Long natural fibers are advantageously fibers taken from plants, in particular linen fibers. Alternatively, the long natural fibers are fibers of sisal, jute, hemp, kenaf. Artificial fibers are for example chosen from regenerated cellulose fibers, such as viscose.

The synthetic fibers are formed from derivatives of oil or molecules from green chemistry (for example, the ethylene resulting from bio ethanol). Fibers suitable for this method include polyolefin fibers, such as fibers of polyethylene and/or polypropylene, polyester, polyamide, polyimide, and mixtures thereof. They can also be bi-component fibers formed from a polymer and a copolymer, the polymer and its copolymer having different melting points. Thus, the chosen synthetic fibers preferably have a base of thermoplastic polymers, which makes it possible, during a thermoforming step at the melting temperature of the polymer, to produce bonding of the linen fibers.

Advantageously, the weight proportion of long fibers of natural origin in each web 16 is greater than 50% of the total mass of the fibers of that web 16.

The fibers of the web 16 are parallel to the longitudinal direction. Thus, the long fibers of the web 16 are generally positioned parallel to one another. This type of web is therefore fundamentally different from the webs obtained by carding, which is the most commonly used method of obtaining a web. Indeed, the card webs must be made from fibers with a length generally shorter than 15 cm and including a certain degree of creping to allow the carding itself and the transverse cohesion of the web. Such a web type therefore by nature has superimposed fibers, even if the fibers remain oriented in the working direction of the card for the most part. When this web is superimposed on itself by burling, the resulting mat will therefore be extremely bulky due to the multiple fiber intersections.

However, the web 16 includes fibers that are perfectly parallel (the parallelism being further accentuated by the fact that natural fibers such as linen or hemp have very little creping). The transverse cohesion of this type of web is only possible owing to the impregnation of a resin, since the fibers do not overlap.

In order to facilitate the adhesion of each mat 12A, 12B on the separator 14, this separator 14 can optionally be equipped with a sheet 18A, 18B, for example of paper or cardboard, arranged at the interface between this mat 12A, 12B and the separator 14.

Furthermore, at least one of the faces of the structural part can optionally be provided with a facing 20 giving the structural part 10 its aesthetic appearance.

A manufacturing method for the structural part 10 will now be described. Such a method first includes producing at least one continuous web of fibers. As will be described in more detail below, this production of webs includes a step for bringing a plurality of separate ribbons of fibers to be parallel, at least one ribbon, preferably each of the ribbons, containing long fibers, for example natural long fibers, then a step for the dispersion of adjacent ribbons through a pin field to form a strip of parallel fibers, a step for tensing and stretching the strip in the pin field parallel to a movement axis.

More particularly, each web 16 is formed from longitudinal ribbons of fibers that are brought into parallel and that are dispersed to form a strip of parallel fibers, the fibers of the strip next being bonded.

“Strip” refers to a longitudinal element including an assembly of fibers, in particular long fibers. The strips are for example obtained by combing or carding, then by tensing individual fibers that are next grouped together with one another to form a longitudinal bond.

The thickness of the ribbon is generally approximately its width. It is for example comprised between 0.5 and two times its width.

The ribbon can advantageously be obtained from unit ribbons that are lined by being superimposed on one another. The thickness of the ribbons is for example greater than 15 mm and comprised between 10 mm and 40 mm, and the width of the ribbons is for example less than 30 mm.

If the web 16 is made up of natural long fibers, for example long linen fibers, all of the ribbons are ribbons of natural long fibers advantageously obtained by aligning unit ribbons with long natural fibers.

If the web 16 includes additional synthetic fibers, at least one ribbon is formed from a unit ribbon made up of long natural fibers and from at least one unit ribbon made up of synthetic fibers. When artificial synthetic fibers are used, the ribbon can be made by stretch-breaking from a set of continuous filaments directly from extrusion or the use of a converter (converting). Thus, the carding step can be avoided.

In all cases, the ribbons are each dispersed in a pin field (not shown), then are tensed and grouped together by superposition on one another.

The pin field for example includes a plurality of rows of parallel and transverse pins relative to a movement axis. A tensing system is provided, including at least one upstream roller and at least one downstream roller positioned transversely on either side of the pin field.

Thus, for the manufacturing method of the structural part 10, at least one continuous web of fibers thus produced is provided, comprising long fibers, at least some of the long fibers of the web having a length greater than 20 centimeters, in particular greater than 50 centimeters.

The manufacturing method next includes a step for impregnating this web with a compound in particular including a thermosetting resin.

This compound can further include at least one additive, for example pigments or dyes, a surfactant and/or a thickener. Thus, the impregnated web can have an aesthetically pleasing appearance owing to this compound, for example a wood-like appearance. In this case, it will not be necessary to add a facing 20 on the faces of the structural part 10, which makes it possible to reduce the mass of the structural part accordingly.

Said impregnation step can be done in different ways, but it is always followed by drying to eliminate the water contained in the compound, which will allow the resin to perform a first bonding of the fibers to one another, but without cross-linking. For example, the impregnation step may consist of vaporization of the compound on the web. This method is well suited to very light webs (<50 g/m²). For heavier webs, the resin risks not completely penetrating the thickness of the web.

Alternatively, it is possible to carry out this impregnation step using any of the known contact coating devices, for example the “pin roller” device comprising two cylinders, at least one of which includes slots for receiving the compound, the web of fibers passing between the cylinders such that the cylinders exert pressure on this web, thus ensuring the penetration of the compound in the web. This second method allows good impregnation in particular for heavy webs (50 to 150 g/m²), but has a risk of winding of the free ends of the fibers around the cylinders, which can cause jams.

In another alternative, the impregnation step includes vaporization of the compound on the web, followed by a first drying, then an additional impregnation done as before using a “pin roller” device, followed by a second drying. Indeed, in this case, the first vaporization of the compound on the web makes it possible to secure the free ends of the fibers on the surface of the web, in order to limit the risks of these free ends winding around the cylinders of the pin roller device.

Advantageously, said compound has a high solids content. Thus, the drying is made easier, which allows a high speed of the impregnation line, limited drying means.

It should be noted that the thermosetting resin must make it possible to maintain the fibers relative to one another without cross-linking. Indeed, the cross-linking is done later during the manufacturing strictly speaking of the structural part 10. A resin able to perform these two functions of maintaining the web by transitional bonding of the fibers after drying, then forming the composite by cross-linking in a hot mold, is the Acrodur® resin by BASF. The weight percentage of solid content of the resin varies greatly between 35% and 65% of the total weight of the impregnated web.

It should be noted that the transitional bond between the fibers is relatively weak and is intended only to allow manipulation of the web, in particular to allow it to be stacked by automatic means in order to form the mat 12A, 12B, for example at the end of the impregnation line. As a result, the fibers will remain mobile relative to one another in the mold when higher stresses are applied to them, during closing of the mold, before cross-linking of the resin.

Thus, it is possible to shape the mats 12A, 12B, in particular to give them a three-dimensional shape, since the fibers of the webs 16 retain good mobility relative to one another as long as the resin is not cross-linked.

This manufacturing is done using a heating mold 22, shown in FIG. 3.

Thus, the manufacturing method includes a stacking step, in this heating mold 22, of the first mat 12A, the separator 14, and the second mat 12B, the separator 14 being positioned between the first 12A and second 12B mats.

The method next includes a step for compression and heating of the stack, the heating being done at a temperature and for a duration allowing cross-linking of the thermosetting resin. During cross-linking, the resin firmly bonds the fibers of each web to one another, and the different webs to one another, as well as the mats 12A, 12B to the separator 14.

The mats 12A, 12B already being particularly dense and thin, the compression can be done at a relatively low pressure, which thus makes it possible to avoid deterioration of the separator 14.

The resin can take up all of the space between the fibers and thus constitute the matrix of a true composite.

It should be noted that a single compression and heating step is necessary for the manufacturing method, such that this manufacturing method is particularly cost-effective. In particular, the mats 12A, 12B being particularly thin and already very dense, it is not necessary to perform an additional compression step of these mats as was the case in the state of the art. In particular, a mat 12A, 12B including 45% solid content of Acrodur® resin (weight percentage relative to the total weight after drying impregnation) made through the superposition of the three webs of 150 g/m² of linen fibers has a thickness of approximately 6 mm. This thickness will need to be decreased to 0.5 mm (density 0.9) by compression in the mold to obtain a Young's modulus of 20 Giga Pascal, which leads to satisfactory mechanical properties of the structural part.

The thermosetting resins retaining their properties at high temperatures, the creep behavior of the structural part is excellent.

Advantageously, the parts of the mold 22 in contact with the mats 12A, 12B can be textured, for example grained, in order to improve the appearance of these mats 12A, 12B, for example to accentuate the wood-like effect by creating grains or a specific grain.

As previously indicated, a sheet 18A, 18B can be inserted between each mat 12A, 12B and the separator 14, in order to improve the attachment of the mats 12A, 12B on that separator 14. Indeed, the separator 14 being a honeycomb, each mat 12A, 12B is only bonded by the thermosetting resin on the end edges of the walls 15 in the absence of such a sheet 18A, 18B. Furthermore, the adhesion between the separator 14 and the mats 12A, 12B is done by the resin already contained in the mats 12A, 12B. The quantity of resin available at the interface may prove insufficient for good adhesion.

However, when such a sheet 18A, 18B is present, each mat 12A, 12B is connected to that sheet along a continuous surface. These sheets 18A, 18B are glued to the separator 14, preferably during the manufacture of the separator 14, for example using a glue whereof the quantity can easily be chosen for optimal gluing. Furthermore, this prior gluing can be done continuously and thus does not cause a significant excess cost.

Additionally, this prior gluing of sheets can be done continuously and thus does not cause a significant excess cost.

Such a sheet 18A, 18B can be made from paper or a nonwoven of the “spunbond” type with the low grammage (40 to 60 g/m²).

Alternatively, the separator 14 can be coated on both of its faces during its manufacture, by the same thermosetting resin as that used for the production of the skins. This resin deposition can be done by vaporization followed by drying without cross-linking and can optionally relate to the entirety of the walls of the cells to ensure the continuous presence of the resin on the thickness of the structural part 10. This additional contribution of resin at the interface between the separator 14 and the mats 12A, 12B makes it possible to ensure better adherence after forming of the skins on the separator 14.

However, preferably, the structural part 10 does not include such a sheet 18A, 18B, in order to limit its mass, and its manufacturing method does not include a prior step for depositing resin on the separator 14 in order to keep the method as simple as possible.

Alternatively, the adhesion on the separator 14 is done by melting of the percentage of synthetic fibers initially present in the web, the polymer of said fibers also being able to act as a matrix in addition to or in place of the thermosetting resin.

It will be noted that the invention is not limited to the embodiment described above, but could assume various alternatives without going beyond the scope of the claims.

1. A structural part for a motor vehicle, of the type comprising:
a first mat and a second mat, each mat comprising fibers and a resin binding the fibers, and
a separator having opposite faces, the separator being inserted between the first and second mats, the first and second mats being respectively fixed on the opposite faces of the separator,
wherein at least one of the first and second mats includes at least one continuous web of fibers, said continuous web of fibers comprising a plurality of parallel fibers bonded together by a thermosetting resin, at least part of the fibers of each continuous web of fibers having a length greater than 20 cm.

2. The structural part according to claim 1, wherein at least one, of the first and second mats includes a plurality of stacked continuous webs of fibers.

3. The structural part according to claim 2, wherein the stacked continuous web of fibers are stacked such that the parallel fibers of each stacked continuous web of fibers are positioned so as to form a non-zero angle with the parallel fibers of each other adjacent continuous web of fibers.

4. The structural part according to claim 2, wherein each of the first and second mats including a plurality of stacked continuous webs of fibers, the first and second mats respectively includes different numbers of stacked continuous webs of fibers.

5. The structural part according to claim 1, wherein at least some of the parallel fibers are natural fibers.

6. The structural part according to claim 1, wherein at least some of the parallel fibers are artificial or synthetic fibers.

7. A manufacturing method for manufacturing a structural composite part of a motor vehicle wherein the method includes:
manufacturing a first mat and a second mat, the manufacturing comprising, for at least one of the first and second mats:
providing a continuous web of fibers comprising long fibers, at least some of the long fibers of the web having a length greater than 20 cm, and
impregnating the continuous web of fibers with an impregnating compound including a thermosetting resin,
providing a separator having opposite faces,
assembling the separator with the first and second mats, at least one of which includes a continuous web of fibers, the separator being inserted between the first and second mats, the first and second mats being fixed respectively on the opposite faces of the separator.

8. The manufacturing method according to claim 7, wherein the impregnating compound includes at least one additive from the following list: pigments or dyes, a surfactant and/or a thickener.

9. The manufacturing method according to claim 7, wherein the impregnation is carried out using two cylinders, at least one of which includes slots for receiving a compound, the continuous web of fibers passing between the cylinder such that the cylinders exert pressure on the continuous web of fibers, ensuring the penetration of the compound in the continuous web of fibers.

10. The manufacturing method according to claim 7, wherein the impregnation includes vaporization of the compound on the continuous web of fibers, followed by expressing.

11. The manufacturing method according to claim 7, wherein the impregnation includes a vaporization of a compound on the continuous web of fibers, following by drying, then an impregnation is carried out using two cylinders, at least one of which includes slots for receiving a compound, the continuous web of fibers passing between the cylinder such that the cylinders exert pressure on the continuous web of fibers, ensuring the penetration of the compound in the continuous web of fibers.

12. The manufacturing method according to claim 8, wherein the impregnation compound has a high solid content.

13. The manufacturing method according to claim 7, wherein each continuous web of fibers is produced over the following steps:
bringing a plurality of separate ribbons of fibers into parallel, at least one ribbon containing long fibers;
dispersion of the adjacent ribbons through a pin field to form a strip of parallel fibers;
tensing and stretching the strip in the pin field parallel to a movement axis, so as to get a stretched strip;
bonding the fibers of the stretched strip to form the web of fibers.

14. The manufacturing method according to claim 7, comprising the following steps:
stacking, in heating mold, the first mat, the separator and the second mat, the separator being positioned between the first and second mats, and at least one of the first and second mats including at least one continuous web of fibers impregnated with the impregnation compound including a thermosetting resin,
compression and heating of the stack, the heating being done at a temperature and for a duration allowing the cross-linking of the thermosetting resin.

15. The structural part according to claim 1, wherein at least part of the fibers of each continuous web of fibers has a length greater than 50 cm.

16. The structural part according to claim 1, wherein at least one of the first and second mats include between three and eight stacked continuous webs of fibers.

17. The structural part according to claim 1, wherein each of the first and second mats includes a plurality of stacked continuous webs of fibers.

18. The structural part according to claim 3, wherein the parallel fibers of each stacked continuous web of fibers are positioned so as to form a right angle with the parallel fibers of each other adjacent continuous web of fibers.

19. The structural part according to claim 5, wherein the natural fibers are one or more of the following types of natural fibers: linen, hemp, kenaf or jute.

20. The structural part according to claim 6, wherein at least some of the parallel fibers are made of thermoplastic.
